(19) United States
(12) Patent Application Publication
(10) Pub. No.: US 2013/0103638 A1
(43) Pub. Date: Apr. 25, 2013

(54) COMPUTING A HIERARCHICAL PATTERN QUERY FROM ANOTHER HIERARCHICAL PATTERN QUERY

(71) Applicants: Chetan Kumar Gupta, Austin, TX (US); Song Wang, Cupertino, CA (US); Abhay Mehta, Austin, TX (US); Mo Liu, San Jose, CA (US); Elke Rundensteiner, Acton, MA (US)

(72) Inventors: Chetan Kumar Gupta, Austin, TX (US); Song Wang, Cupertino, CA (US); Abhay Mehta, Austin, TX (US); Mo Liu, San Jose, CA (US); Elke Rundensteiner, Acton, MA (US)

(21) Appl. No.: 13/280,342

(22) Filed: Oct. 25, 2011

(51) Int. Cl. G06F 17/30; G06F 7/00

(52) U.S. Cl. 707/603; 707/769; 707/775; 707/E17.014; 707/E17.009

(57) ABSTRACT

A method analyzes event patterns in multi-dimensional data and based on this analysis of the event patterns computes a hierarchical event pattern query from another hierarchical event pattern query. The method executes the hierarchical event pattern query on the multi-dimensional data.

### BACKGROUND

Many applications generate real-time streaming data, applications such as online financial transactions, IT operations management, and sensor networks. This streaming data has many dimensions (time, location, objects), and each dimension can be hierarchical in nature.

Given such streaming data, it is often desirable to analyze multiple pattern queries that exist at various abstraction levels in real-time.

### BRIEF DESCRIPTION OF THE DRAWINGS

FIG. 1 shows several sample pattern queries for a tracking system in accordance with an example implementation.

FIG. 2 shows hierarchical instance stacks for pattern queries in FIG. 1 in accordance with an example implementation.

FIG. 3 shows other hierarchical instance stacks for pattern queries in FIG. 1 in accordance with an example implementation.

FIG. 4 shows a method in accordance with an example implementation.

FIG. 5 shows a computer system in accordance with an example implementation.

### DETAILED DESCRIPTION

Example embodiments include apparatus, systems, and methods that provide event pattern analysis over multi-dimensional data in real-time in order to compute one hierarchical event pattern query from another. A cost for this computation is also generated.

Example embodiments analyze vast amounts of multi-dimensional sequence data being streamed into data warehouses or databases. For example, many data warehouses include large amounts of multi-dimensional application data that exhibits logical sequential ordering among individual data items, such as radio-frequency identification (RFID) data and sensor data. Example embodiments utilize an E-Cube to integrate complex event processing (CEP) and online analytical processing (OLAP) techniques to provide pattern analysis functionalities. An E-Cube model is composed of cuboids that associate patterns and dimensions at certain abstraction levels. As one example, the E-Cube differs from a traditional data cube in that the E-Cube aggregates queries over dimensions and patterns. This model leverages OLAP techniques in databases to allow users to navigate or explore the data at different abstraction levels while simultaneously supporting real-time multi-dimensional sequence data analysis. Furthermore, CEP is used for pattern matching in a variety of applications, ranging from RFID tracking for supply chain management to real-time intrusion detection. Example embodiments use E-Cubes to integrate OLAP and CEP techniques for timely real-time multi-dimensional pattern analysis over event streams.

For purposes of illustration, an example embodiment of E-Cube is discussed in connection with a hurricane tracking. Example embodiments, however, can be utilized for pattern detection among event streams in numerous other applications. By way of example, numerous applications generate real-time streaming data, such as applications associated with online financial transactions, information technology (IT) operations management, sensor networks that generate real-time streaming data, radio frequency identification (RFID) technology, etc. It is often desirable to analyze this streaming data and determine multiple pattern queries that exist at different abstraction levels in real-time. Consider an RFID tracking system used to track mass movement of people and goods during natural disasters. Terabytes of RFID data could be generated by such a tracking system. Facing a huge volume of RFID data, emergency personnel need to perform pattern detection on various dimensions at different granularities in real-time. In particular, one may need to monitor people movement and traffic patterns of needed resources (e.g., water and blankets) at different levels of abstraction to ensure fast and optimized relief efforts.

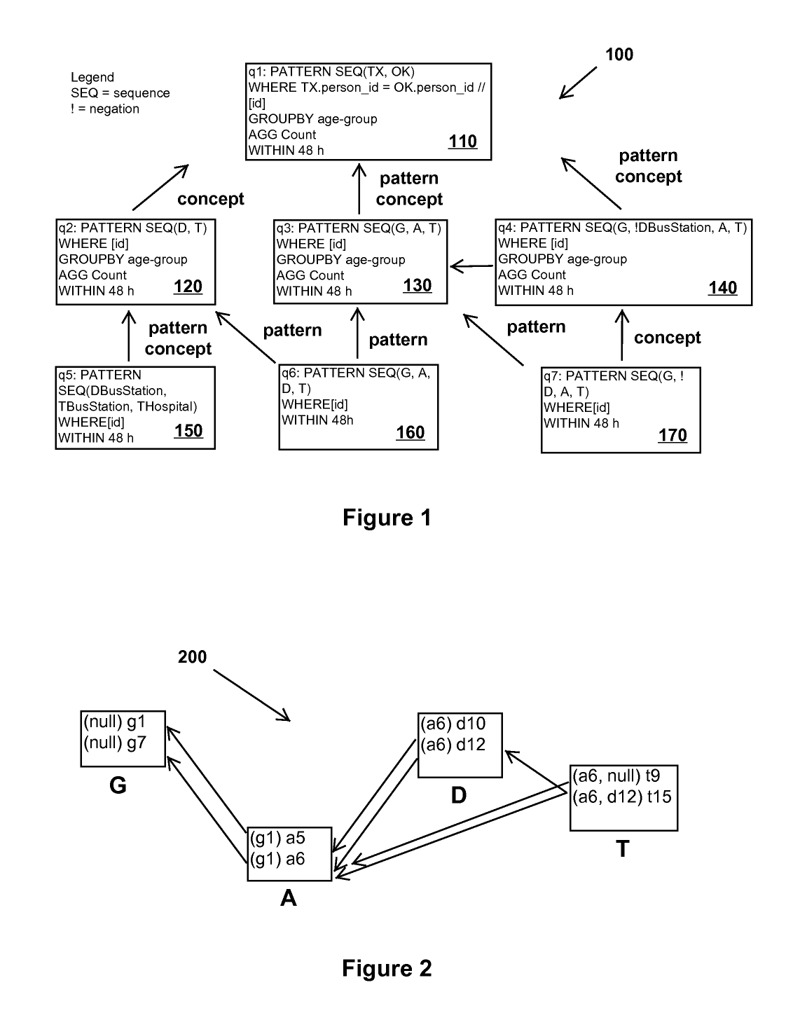

FIG. 1 shows several sample pattern queries for an RFID tracking system 100. The tracking system includes seven queries shown as queries q₁ at 110, q₂ at 120, q₃ at 130, q₄ at 140, q₅ at 150, q₆ at 160, and q₇ at 170. For example, during hurricane Ike federal government personnel might monitor movement of people from cities in Texas to Oklahoma represented by the pattern SEQ(TX, OK) for global resource placement as in q₁ at 110; while local authorities in Dallas may focus on people movement starting from the Dallas bus station, traveling through the Tulsa bus station, and ending in the Tulsa hospital within a 48 hours time window as in q₅ at 150 to determine the need for additional means of transportation.

Example embodiments utilize an E-cube to process and query large volumes of streaming sequence data in real-time at various abstraction levels, such as the data being generated by the RFID tracking system 100. The E-Cube processes workloads of complex pattern detection queries at multiple levels of abstraction over extremely high-speed event streams by effectively leveraging their central processing unit (CPU) resource utilization. Systems and methods utilize the E-Cube to compute one hierarchical event pattern query from another hierarchical event pattern and determine a cost (such as a CPU cost) of such an evaluation.

Example embodiments utilize an E-Cube hierarchy to build a directed acyclic graph H where each node corresponds to a pattern query qᵢ and each edge corresponds to a pair-wise refinement relationship between two pattern queries. Each directed edge <qᵢ, qⱼ> is labeled with either the label “concept” if qᵢ<_{c}qⱼ, “pattern” if qᵢ<ₚqⱼ, or both to indicate the refinement relationship among the two queries qᵢ and qⱼ. FIG. 1 depicts edges labeled as one of concept, pattern, or pattern concept.

A pattern query qᵢ can be rolled up into another pattern query qⱼ by either changing one or more positive (negative) event types to a coarser (finer) level along the event concept hierarchy of that event type, changing the pattern to a coarser level, or both.

With example embodiments, an E-Cube is an E-Cube hierarchy where each pattern query is associated with its query result instances. Each individual pattern query along with its result instances in E-Cube is called an E-cuboid. FIG. 1 shows an example E-Cube hierarchy.

Example embodiments extend OLAP operations by pattern-drill down, pattern-roll-up, concept-roll-up, and concept-drill-down for pattern queries in an E-Cube hierarchy. OLAP-like operations on E-Cubes allow users to navigate from one E-cuboid to another in E-Cube. As one example, the operation pattern-drill-down (qₘ, list [Typeᵢⱼ, Posₖⱼ]) applied to qₘ inserts a list of n event types with the event type Typeᵢⱼ into the position Posₖⱼ of qₘ (1·j·n). As another example, the operation concept-drill-down(qₘ, list [(Typeₘⱼ, Typeₙⱼ), Posₖⱼ]) applied to qₘⱼ drills down a list of event types from Typeₘⱼ to Typeₙⱼ (Typeₘⱼ>_{c}Typeₙⱼ) at the position Posₖⱼ of qₘ (1·j·n). As yet another example, the operation pattern-roll-up(qₘ, list[Typeᵢⱼ Posₖⱼ]) applied to qₘ deletes a list of n event types with the event type Typeᵢⱼ from the position Posₖⱼ of qₘ (1·j·n). As yet another example, the operation concept-roll-up(qₘ, list[(Typeₘⱼ, Typeₙⱼ), Posₖⱼ]) applied to qₘ rolls up a list of event types from Typeₘⱼ to Typeₙⱼ (Typeₘⱼ<_{c}Typeₙⱼ) at the position Posₖⱼ of qₘ (1·j·n).

These concepts are illustrated with regard to FIG. 1. A pattern-drill-down operation on q₃=SEQ(G, A, T) specified by pattern-drill-down (q₃, [(!D, 2)]) in order to obtain q₇=SEQ(G, !D, A, T). A concept-drill-down operation on q₁=SEQ(TX, OK) specified by concept-drill-down (q₁, [(TX, D, 1)]) in order to obtain q₂=SEQ(D, T). A pattern-roll-up operation on q₆=SEQ(G, A, D, T) specified by pattern-roll-up (q₆, [(G, 1), (A, 2)]) in order to obtain q₂=SEQ(D, T). A concept-roll-up operation on q₂=SEQ(D, T) by concept-roll-up (q₂, [(D, TX, 1)]) in order to obtain q₁=SEQ(TX, OK).

The results of pattern-drill-down (pattern-roll-up) can be computed by a general-to-specific (specific-to-general) reuse with only pattern changes. The results of concept-drill-down (concept-roll-up) can be computed by a general-to-specific (specific-to-general) evaluation with only concept changes.

Hierarchical instance stacks (HIS) hold event instances processed by the E-Cube. HIS provides shared storage of events across different concept and pattern abstraction levels. Each instance is stored in a single stack even though it may semantically match multiple event types in an event type concept hierarchy, namely, the finest one in E-Cube hierarchy. HIS is populated with event instances as the stream data is consumed. The stack based query evaluation can be extended to access event instances in hierarchical stacks instead of flat stacks.

Example embodiments utilize E-Cubes to produce query results quickly and improve computational efficiency by sharing results among queries in a unified query plan. Instead of processing each pattern in our E-Cube hierarchy independently using a stack-based strategy, example embodiments compute one pattern from other previously computed patterns within the E-Cube hierarchy.

Concept and pattern relationships between queries identified by the E-Cube model are used to promote reuse and to reduce redundant computations among queries.

Given a workload of pattern queries, the E-Cube model translates the pattern queries into an E-Cube hierarchy H, and then designs a strategy to determine an optimal evaluation ordering for the queries in the E-Cube hierarchy such that the total execution cost is minimized. To achieve this objective of finding an optimal overall execution strategy for completing the workload captured by the E-Cube hierarchy, example embodiments consider three choices when evaluating each query qᵢ in H as follows:
(I) compute qⱼ independently by stack-based join, denoted by C_{compute(qi)};
(II) conditionally compute qⱼ from one of its ancestors qᵢ by general-to-specific evaluation, denoted by C_{compute(qj|qi)};
(III) conditionally compute qⱼ from one of its descendants qᵢ by specific-to-general evaluation, denoted by C_{compute(qj|qi)}.

A parent-child relationship can be either due to pattern changes or concept changes. Concept and pattern relationships exist between queries identified by the E-Cube model to promote reuse and to reduce redundant computations among queries. The model considers two orthogonal aspects, namely, (1) abstraction detection: drill down vs. roll up in E-Cube hierarchy, and (2) refinement type: pattern or concept refinement.

The query reuse can be done in the following ways:

1. General-to-specific with only pattern changes;

2. General-to-specific with only concept changes;

3. General-to-specific with simultaneous pattern and concept changes;

4. Specific-to-general with only pattern changes;

5. Specific-to-general with only concept changes; and

6. Specific-to-general with simultaneous pattern and concept changes.

In order to assist in discussing the example use cases, definitions are provided for the following terms:

(1) C_{compute(qi|qj)} is the evaluation cost for query qᵢ basing on evaluation results for qⱼ.

(2) C_{compute(qi)} is the cost of computing results for a query qᵢ independently.

(3) |Sᵢ| is the number of tuples of type Eᵢ that are in a time window TW_{P}. This can be estimated as Rate_{E}*TW_{P}*P_{E}.

(4) TW_{P} is the time window specified in a pattern query P.

(5) Rate_{E} is the rate of primitive events for the event type E.

(6) P_{E} is the selectivity of the single-class predicates for event class E. This is the product of selectivity of each single-class predicate of E.

(7) Pt_{Ei, Ej} is the selectivity of the implicit time predicate of subsequence (Eᵢ, Eⱼ). The default value is set to ½.

(8) P_{Ei, Ej} is the selectivity of multi-class predicates between event class Eᵢ and Eⱼ. If E₁ and E₂ do not have predicates, this value is set to 1.

(9) |R_{E}| is the number of results for the composite event E.

(10) C_{type} is the unit cost to check type of one event instance.

(11) qᵢ.length is the number of event types in a query qᵢ.

(12) Num_{E} is the number of total events received so far.

(13) Num_{RE} is the number of relevant events received of the types in query set Q.

(14) C_{access} is the cost of accessing one event.

(15) Cₐₚₚ is the unit cost of appending one event to a stack and setting up pointers for the event.

(16) C_{ct} is the unit cost to compare a timestamp of one event instance with another one.

Reuse Case 1: General-to-Specific with Pattern Changes

Considering only pattern changes, the computation of the lower level query can be optimized by reusing results from the upper level query. The two sharing cases are stated as below. Given queries qᵢ and qⱼ (qᵢ>ₚqⱼ) in a pattern hierarchy and the results of qᵢ, then the results for qⱼ can be constructed as bellow. In case I: Differ by positive types, the results of qᵢ with the events of positive types listed in qⱼ but not in qᵢ are joined. In case II: Differ by negative types, the results from qᵢ that do not satisfy the sequence constraints formed by negative event types listed in qⱼ but not in qᵢ are filtered. The pseudo-code for general-to-specific evaluation guided by the pattern hierarchy is shown below:

```
General-to-specific evaluation with only pattern changes (
qᵢ and qⱼ are queries in a pattern hierarchy
with qᵢ > ₚ qⱼ; R_{qi} -- the results of qᵢ)
01 R_{qj} = R_{qi}
02 for every negative Eₖ ε qⱼ but Eₖ ∉ qᵢ
03 R_{qj} = checkNegativeE(R_{qj}, Eₖ, qⱼ)
04 for every positive Eᵢ ε qⱼ but Eᵢ ∉ qᵢ
05 if(joining events in R_{qj} and Eᵢ are
    sorted and pointers exist)
06 R_{qj} = stack-based-join(R_{qj}, Eᵢ);
07 else if(events are sorted with no pointers)
08 R_{qj} = merge-join(R_{qj}, Eᵢ);
09 else R_{qj} = sorted-merge-join(R_{qj}, Eᵢ);
checkNegativeE(R_{qj} , Eₖ, qⱼ)
01 for each result rᵢ ε R_{qj}
02 if (Eₖ events exist in the specified interval)
    remove rᵢ
```

For case I above, the costs for the compute operation depend on two factors, namely (1) if pointers exist between joining events and (2) if the re-used result is ordered or not on the joining event type. Assume two pattern queries qᵢ=SEQ(Eᵢ, Eⱼ, Eₖ) and qⱼ=SEQ(Eᵢ, Eⱼ, Eₖ, Eₘ, Eₙ) differ by two positive event types Eₘ and Eₙ. Also, assume pointers exist between events of type Eₘ and Eₙ. To compute qⱼ, results are constructed for SEQ(Eₘ, Eₙ) by an efficient stack-based join. These results will by default be sorted by Eₙ's timestamp. These results are then joined with qᵢ results using the most appropriate join method.

The definitions provided above show the factors used in the cost estimation in Equation 1 shown below:

$${C}_{compute ( qj \vert qi ) . gp} = \vert {S}_{m} \vert * \vert {S}_{n} \vert * {Pt}_{Em , En} * {P}_{Em , En} + \vert {R}_{SEQ ( Em , En )} \vert log \vert {R}_{SEQ ( Em , En )} \vert + \vert {R}_{qi} \vert * \vert {R}_{SEQ ( Em , En )} \vert * {Pt}_{Ek , Em} * {P}_{Ek , Em} + \vert {R}_{SEQ ( Em , En )} \vert + \vert {R}_{qi} \vert$$

For case II, assume two pattern queries qᵢ=SEQ(Eₘ, Eₙ) and qⱼ=SEQ(Eₘ, !Eₖ, Eₙ) differ by one negative event type Eₖ. For every qᵢ result, it can be returned for qⱼ if no Eₖ events are found between the particular interval in qⱼ. The cost formula is shown in Equation 2 below:

C_{compute(qj|qi).gp}=|Sₘ|*|Sₙ|*Pt_{Em, En}*P_{Em, En}*(1−Pt_{Em, Ek}*P_{Ek, En})

Besides this computation sharing, online pattern filtering can also be achieved and thus potentially save the computation costs of qᵢ completely (C_{compute(qi)}). Specifically, if a pattern qᵢ is at a coarser level than a pattern qⱼ, and a matching attempt with qᵢ fails, then there is no need to carry out the evaluation for qⱼ. That is, qⱼ will also fail since it is stricter.

Example 1: Given pattern queries q₃ at 130, q₆ at 160, and q₇ at 170 in FIG. 1, q₃ at 130 and q₆ at 160 differ by one event type D, and q₃ at 130 and q₇ at 170 differ by one event type !D. The results for q₃ at 130 are checked first. If no new matches are found, then it is known that the results for q₆ at 160 and q₇ at 170 would also be negative. Thus, their evaluation is skipped. If new matches for q₃ at 130 are found, then no pointers exist between results of q₃ at 130 and events of type D. Yet the joining attributes for T and D, namely, D.ts and T.ts are sorted on timestamps. The merge join is applied to compute q₆ at 160.

Reuse Case 2: General-to-Specific with Concept Changes

Considering only concept changes, composite results constructed involving events of the highest event concept level are a super-set of pattern query results below it in an ECube hierarchy. The lower level query can be computed by reusing and further filtering the upper query results.

Given two pattern queries qᵢ and qⱼ with only concept changes (qᵢ>c qⱼ) on positive event types, a cost model is formulated in Equation 3 shown below:

C_{compute(qj|qi).gc}=|R_{qi}|*C_{type}*qᵢ.length.

For each result of qᵢ, the event types for the constructed composite event instances are interpreted to determine which of them indeed match a given lower level type. The strategy becomes less efficient as the number of results to be re-interpreted increases.

Example 2: In FIG. 1, from q₁ at 110 to q₂ at 120 only the concept hierarchy level is changed. Here, q₁ is computed before q₂, and the results are cached. Since the results of q₂ satisfy q₁, q₂ can be computed by re-interpreting the q₁ results. If one result with component events of types TX and OK is also a composite event with types D and T, then that particular result will be returned for q₂. Otherwise, the result will be filtered out.

Given two pattern queries qᵢ=SEQ(Eₘ, !Eₖ₁, Eₙ) and qⱼ=SEQ(Eₘ, !Eₖ, Eₙ) with only concept changes (qᵢ>_{c}qⱼ) on negative event types where Eₖ is a super concept of Eₖ₁ in the event concept hierarchy. To facilitate query sharing, qⱼ is rewritten into the expression shown in Equation 4 below:

SEQ(Eₘ, !Eₖ, Eₙ)=SEQ(Eₘ, !Eₖ₁̂ . . . !̂Eₖₙ, Eₙ).

For every qᵢ result, it can be returned for qⱼ if no Eₖ₂, Eₖ₃ . . . and Eₖₙ events are found between the position in a specified query.

Example 3: In FIG. 1, when computing q₇ at 170 from q₄ at 140, each q₄ result is qualified for q₇ if no DHospital and DShelter events exist between G and A events.

Reuse Case 3: General-to-Specific with Concept & Pattern Refinement

Given qᵢ and qⱼ in an E-Cube hierarchy with simultaneous concept and pattern changes (qᵢ>_{cp}qⱼ), the cost to compute the child qⱼ from the parent qᵢ corresponds to Equation 5 below:

$${C}_{compute ( qj \vert qi )} = {min}_{p} ( {C}_{compute ( p \vert qi )} + {C}_{compute ( qj \vert p )} )$$

where p has either only concept or only pattern changes from qᵢ and qⱼ, respectively.

The idea is to consider this as a two-step process that composes the strategies for concept and then pattern-based reuse (or, vice versa) effectively with minimal cost.

Reuse Case 4: Specific-to-General with Pattern Changes

Given queries qᵢ and qⱼ (qᵢ>ₚqⱼ) in a pattern hierarchy and the results of qⱼ, then qᵢ can be computed by reusing qⱼ results and unioning them with the delta results not captured by qⱼ. Our compute operation includes two key factors, namely, result reuse and delta result computation. The pseudo-code for the specific-to-general evaluation is below:

```
Specific-to-general evaluation with only pattern changes (
qᵢ and qⱼ are queries in a pattern hierarchy
with qᵢ > ₚ qⱼ; R_{qi} -- the results of qᵢ)
01 R_{qi} = ReuseSubpatternResult(qᵢ, qⱼ, R_{qj})
02 R_{qi} = R_{qi} ∪ ComputeDeltaResults(qᵢ, qⱼ)
ReuseSubpatternResult(qᵢ, qⱼ , R_{qj})
01 for each result rₖ ε R_{qj}
02 for each component eᵢ ε rₖ
    if(eᵢ.type ∉ qⱼ [symbol]   eᵢ.type ε qᵢ)
    remove eᵢ from rₖ;
ComputeDeltaResults(qᵢ, qⱼ)
01 for each positive event type Eᵢ or
    SEQ(Eᵢ ,..., Eₖ) ε qⱼ but ∉ qᵢ
02 construct results for qᵢ with events failed
    in qⱼ due to non-existence of Eᵢ or
    SEQ(Eᵢ, Eⱼ, ..., Eₖ) events
03 for each negative event type Eᵢ ε qⱼ but ∉ qᵢ
04 construct results for qᵢ with events
    failed in qⱼ due to existence of Eᵢ events
```

In general, assume qᵢ=SEQ(Eᵢ, Eⱼ, Eₖ) is refined by an extra event Eₘ into qⱼ=SEQ(Eᵢ, Eₘ, Eⱼ, Eₖ). qⱼ results are reused for qᵢ and SEQ(Eᵢ, !Eₘ, Eⱼ, Eₖ) results are the delta results. The cost model is given in Equation 6 below:

C_{compute(qi|qj).sp}=|R_{qj}|*C_{type}*qⱼ.length+|Sₖ|*|Sⱼ|*Pt_{Ej}, Eₖ*P_{Ej, Ek}+|Sₖ|*|Sⱼ|*Pt_{Ej, Ek}*P_{Ej, Ek}*|Sᵢ|*P_{Ei, Ej}*P_{Ei, Ej}*(1−P_{Ei, Ej}*P_{Em, Ej}*P_{Ei, Ej}*P_{Em, Ej})

This specific to-general computation for a pattern hierarchy would need to check the non existence of a possibly long intermediate pattern for delta result computation when two queries differing by more than one event type. These overhead costs in some cases may not warrant the benefits of such partial reuse. When two queries differ by negative event types, the specific-to-general method is similar to above except that during delta result computation we need to compute some additional sequence results filtered in the specific query due to the existence of events of negative types.

Example 4: FIG. 2 shows the hierarchical instance stacks 200 for pattern queries q₃ and q₆ in FIG. 1. Result reuse and delta result computation for q₃ are explained below.

ReuseSubpatternResult. Q₃ is computed from the results of q₆ by subtracting subsequences composed of positive event types G, A and T. For example, in FIG. 2, the result <g₁, a₅, d₁₀, t₁₅> for q₆ is first generated using the stack-based join method. Then <g₁, a₅, t₁₅> is prepared for q₃ by removing the event d₁₀ of the event type D, because D is not listed in q₃. A check is then performed to determine whether this result is duplicated before returning it for q₃.

ComputeDeltaResults. Some sequences may not have been constructed for q₆ due to the non-existence of events of type D. Such sequence results, however, are constructed for q₃. In this case, each instance of type T has one pointer to an A event for q₃ and another pointer to a D event for q₆. Hence, for a T event that does not point to any D event, an inference is made that a sequence involving this T event would not have been constructed for q₆. This T event thus should trigger its sequence construction for q₃ by a stack-based join. If one T event points to both an A and a D event, then the A and D events may still not satisfy the time constraints. If the timestamp of the A event is greater than the timestamp of the D event, sequence construction is triggered by such T event for q₃. In FIG. 2, t₉ does not point to any D event. Hence sequence results <g₁, a₅, t₉> and <g₁, a₆, t₉> are constructed for t₉ by a stack-based join. The conditional cost to compute q₃ includes the costs of result reuse and the cost to compute SEQ(G,A, !D, T) results.

Reuse Case 5: Specific-to-General with Concept Changes

The result set of a higher concept abstraction level is a super set of the results of pattern queries below it. Thus an upper level query can be computed in part by reusing the lower level query results. The lower level pattern query is computed first. Then these results are also returned for the upper level pattern. In addition, the events of the higher event type concept level not captured by the lower queries are also constructed. Such specific-to-general computation requires no extra interpretation costs as compared to the general-to-specific evaluation. Given two pattern queries qᵢ and qⱼ with only concept changes (qᵢ>_{c}qⱼ), a cost model is formulated by Equation 7 below:

C_{compute(qi|qj).sc}=C_{compute(qi)}−C_{compute(qj)}.

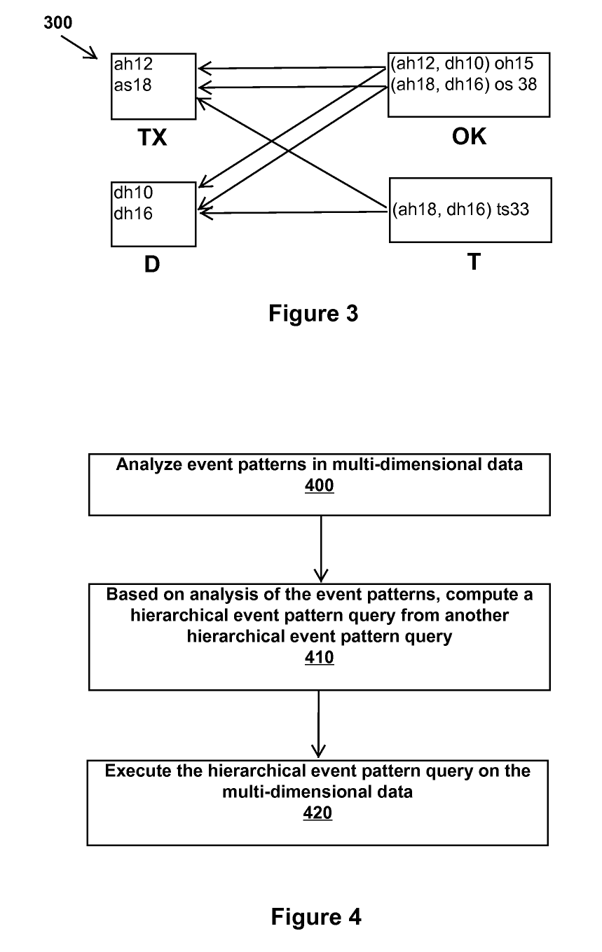

Example 5: FIG. 3 shows the hierarchical instance stacks 300 for q₁ to q₂ in FIG. 1. From q₁ to q₂ only concept relationships are refined. Results for q₂ {dh₁₀, ts₃₃}, {dh₁₆, ts₃₃} are computed first, and these results are also returned for q₁. Next, the delta results belonging to q₁ that were not captured by q₂ are computed. In FIG. 3, the pointers between D and T are already traversed during the evaluation of q₂. The other pointers between D and OK, TX and OK, TX and T need now to be traversed. Results {ah₁₂, oh₁₅}, {ah₁₀, oh₁₅}, {ah₁₂, oh₃₈}, {as₁₈, os₃₈}, {dh₁₀, os₃₈}, {dh₁₈, os₃₈}, {ah₁₂, ts₃₃}, {as₁₈, ts₃₃} are constructed for q₁.

Reuse Case 6: Specific-to-General with Concept & Pattern

Given qᵢ and qⱼ in an E-Cube hierarchy with simultaneous concept and pattern changes (qᵢ>_{cp}qⱼ), one intermediate query p is found with either only concept or pattern changes from qⱼ so that query p minimizes Equation 8 below:

$${C}_{compute ( qi \vert qj )} = {p}^{min} ( {C}_{compute ( p \vert qj )} + {C}_{compute ( qi \vert p )} )$$

where p has either only concept or only pattern changes from qᵢ and qⱼ, respectively.

As above, results are computed in two stages from qⱼ to p and from p to qᵢ by using specific-to-general evaluation with first only pattern and then only concept changes or vice versa effectively with minimal cost.

Example embodiments thus allow for results sharing across queries and also include a cost model to compute the cost of such execution. These costs can be input to an optimizer than can then create an optimal plan to execute a large set of queries.

FIG. 4 is a method in accordance with an example embodiment.

According to block 400, event patterns are analyzed in multi-dimensional data.

According to block 410, based on analysis of the event patterns, a hierarchical event pattern query is computed from another hierarchical event pattern query.

One example embodiment utilizes an E-Cube to perform the computations. For example, an E-Cube model is built of multi-dimensional data with cuboids that aggregate the multi-dimensional data over both patterns and dimensions. The E-Cube model integrates both event processing (CEP) and online analytical processing (OLAP) techniques to perform pattern analysis over event streams in the multi-dimensional data.

According to block 420, the hierarchical event pattern query is executed on the multi-dimensional data.

After the query is executed, results of the query are provided to a computer and/or user. For example, the results of the query are displayed on a display, stored in a computer, or provided to another software application.

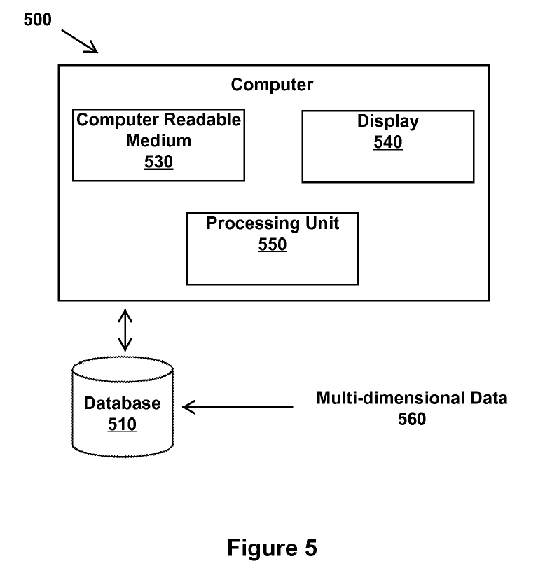

FIG. 5 is a block diagram of a computer system 500 in accordance with an example embodiment. The computer system includes a multi-dimensional database or warehouse 510 in communication with one or more computers or electronic devices 520 that include one or more of a memory and/or computer readable medium 530, a display 540, and a processing unit 550. Multi-dimensional data 560 is streamed or provided to the multi-dimensional database or warehouse 510. The term “multidimensional database” means a database wherein data is accessed or stored with more than one attribute (a composite key). Data instances are represented with a vector of values, and a collection of vectors (for example, data tuples) is a set of points in a multidimensional vector space.

In one embodiment, the processor unit includes a processor (such as a central processing unit, CPU, microprocessor, application-specific integrated circuit (ASIC), etc.) for controlling the overall operation of the memory 530 (such as random access memory (RAM) for temporary data storage, read only memory (ROM) for permanent data storage, and firmware). The processing unit 550 communicates with memory that stores instructions to execute or assist in executing methods discussed herein.

Blocks discussed herein can be automated and executed by a computer or electronic device. The term “automated” means controlled operation of an apparatus, system, and/or process using computers and/or mechanical/electrical devices without the necessity of human intervention, observation, effort, and/or decision.

The methods in accordance with example embodiments are provided as examples, and examples from one method should not be construed to limit examples from another method. Further, methods discussed within different figures can be added to or exchanged with methods in other figures. Further yet, specific numerical data values (such as specific quantities, numbers, categories, etc.) or other specific information should be interpreted as illustrative for discussing example embodiments. Such specific information is not provided to limit example embodiments.

In some example embodiments, the methods illustrated herein and data and instructions associated therewith are stored in respective storage devices, which are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to any manufactured single component or multiple components.

What is claimed is:

1) A method executed by a computer, comprising:
analyzing, by the computer, event patterns in multi-dimensional data;
computing, by the computer and based on analysis of the event patterns, a hierarchical event pattern query from another hierarchical event pattern query; and
executing, by the computer, the hierarchical event pattern query on the multi-dimensional data.

2) The method of claim 1 further comprising, utilizing an E-Cube to integrate complex event processing (CEP) and online analytical processing (OLAP) techniques to provide the analysis of the event patterns.

3) The method of claim 1 further comprising, determining a processing cost to execute the hierarchical event pattern query and the another hierarchical event pattern query.

4) The method of claim 1 further comprising, reusing results from an upper level query to compute a lower level query by considering only pattern changes.

5) The method of claim 1 further comprising, reusing results from an upper level query to compute a lower level query by considering only concept changes.

6) A non-transitory computer readable storage medium comprising instructions that when executed causes a computer system to:
analyze multi-dimensional streaming data to determine multiple hierarchical pattern queries that exist a different abstraction levels;
compute, with an E-Cube, one hierarchical pattern query from another hierarchical pattern query of the multiple hierarchical pattern queries; and
execute the hierarchical event pattern query on the multi-dimensional streaming data.

7) The non-transitory computer readable storage medium of claim 6 including instructions to further cause the computer system to: leverage, with the E-Cube, online analytical processing (OLAP) techniques to enable navigation of the multi-dimensional streaming data at different abstraction levels while simultaneously supporting real-time multi-dimensional sequence data analysis.

8) The non-transitory computer readable storage medium of claim 6 including instructions to further cause the computer system to: calculate a cost to compute a child qᵢ from a parent qⱼ given qᵢ and qⱼ in an E-Cube hierarchy with simultaneous concept and pattern changes, where qᵢ and qⱼ are pattern queries.

9) The non-transitory computer readable storage medium of claim 6 including instructions to further cause the computer system to: identify, by the E-Cube, concept and pattern relationships between the multiple hierarchical pattern queries in order to reduce redundant computations among the multiple hierarchical pattern queries.

10) The non-transitory computer readable storage medium of claim 6 including instructions to further cause the computer system to: roll up one of the multiple hierarchical pattern queries into another of the multiple hierarchical pattern queries.

11) A computer system, comprising:
a memory storing instructions; and
a processor executing the instructions to analyze multi-dimensional data to determine multiple hierarchical pattern queries, use an E-Cube to compute one hierarchical pattern query from another hierarchical pattern query of the multiple hierarchical pattern queries, and execute the hierarchical event pattern query on the multi-dimensional data.

12) The computer system of claim 11 wherein the processor further executes the instructions to: given queries qᵢ and qⱼ in a pattern hierarchy and results of qⱼ, compute the qᵢ by reusing the results of qⱼ and unioning the results of qⱼ with delta results not captured by the qⱼ.

13) The computer system of claim 11 wherein the processor further executes the instructions to: given queries qᵢ and qⱼ in a concept hierarchy and results of qⱼ, compute the qᵢ by reusing the results of qⱼ and unioning the results of qⱼ with delta results not captured by the qⱼ.

14) The computer system of claim 11, wherein the processor further executes the instructions to: compute a lower level query, return results from the lower level query to an upper level query in order to compute the upper level query by reusing the results from the lower level query.

15) The computer system of claim 11 wherein the processor further executes the instructions to evaluate each of the multiple hierarchical pattern queries by one of computing each query independently by stack-based join and computing each query from one of its descendants.

16) The computer system of claim 11 wherein the processor further executes the instructions to: given qᵢ and qⱼ in an E-Cube hierarchy with simultaneous concept and pattern changes, calculate an intermediate query with either only concept or pattern changes from qⱼ, where qᵢ and qⱼ are pattern queries.
